(19) United States
(12) Patent Application Publication
(10) Pub. No.: US 2020/0218905 A1
(43) Pub. Date: Jul. 9, 2020

(54) LATERAL AND LONGITUDINAL OFFSET TRACKING IN VEHICLE POSITION ESTIMATION

(71) Applicant: QUALCOMM Incorporated, San Diego, CA (US)

(72) Inventors: Tianheng WANG, San Diego, CA (US); Muryong KIM, Florham Park, NJ (US); Jubin JOSE, Belle Mead, NJ (US)

(21) Appl. No.: 16/671,052

(22) Filed: Oct. 31, 2019

Related U.S. Application Data
(60) Provisional application No. 62/789,897, filed on Jan. 8, 2019.

(51) Int. Cl. G06K 9/00; G01C 21/30; G01S 19/45

(52) U.S. Cl. CPC G06K 9/00798; G01S 19/45; G01C 21/30

(57) ABSTRACT

Techniques provided herein are directed toward tracking lateral and longitudinal offsets, which can include positioning errors of an initial position estimate as well as inconsistencies between the map and global frames. Tracking lateral and longitudinal offsets in this manner have been shown to help increase the accuracy of subsequent position estimates of a position estimation system for vehicle that uses an initial position estimate based on GNSS and VIO, with error correction based on location data for observed visual features obtained from a map.

### RELATED APPLICATION

This application claims the benefit of U.S. Provisional Application No. 62/789,897, filed Jan. 8, 2019, entitled “UTILIZING LATERAL AND LONGITUDINAL OFFSETS TO TRACK INCONSISTENCIES IN GLOBAL AND MAP COORDINATES AND GNSS AND VIO POSITIONING ERROR”, which is assigned to the assignee hereof, and incorporated by reference herein in its entirety.

### BACKGROUND

Vehicle systems, such as autonomous driving and Advanced Driver-Assist Systems (ADAS), often need highly-accurate positioning information to operate correctly. To provide such accurate positioning, ADAS systems may utilize positioning technologies from a variety of sources. For example, Global Navigation Satellite Systems (GNSS), such as Global Positioning System (GPS) and/or similar satellite-based positioning technologies can be used to provide positioning data, which may be enhanced with (or substituted by, where necessary) Visual Inertial Odometry (VIO), which uses data from motion sensors (e.g., accelerometers, gyroscopes, etc.) and one or more cameras to track vehicle movement. These systems can be used to provide a position estimate of the vehicle in a global coordinate system (or “global frame”).

### BRIEF SUMMARY

Techniques provided herein are directed toward tracking lateral and longitudinal offsets, which can include positioning errors of an initial position estimate as well as inconsistencies between the map and global frames. Tracking lateral and longitudinal offsets in this manner have been shown to help increase the accuracy of subsequent position estimates of a position estimation system for vehicle that uses an initial position estimate based on GNSS and VIO, with error correction based on location data for observed visual features obtained from a map.

An example method of vehicle position estimation, according to the description, comprises obtaining location information for a vehicle, obtaining observation data regarding one or more visual features observed in a camera image taken from the vehicle, and determining a lateral offset and a longitudinal offset based on the location information and the observation data. The method further comprises determining a vehicle position estimate based at least in part on the lateral offset, the longitudinal offset, or both, and providing the vehicle position estimate to a system or device.

An example mobile device, according to the description, comprises a memory, and one or more processing units communicatively connected with the memory. The one or more processing units are configured to obtain location information for a vehicle, obtain observation data regarding one or more visual features observed in a camera image taken from the vehicle, and determine a lateral offset and a longitudinal offset based on the location information and the observation data. The one or more processing units are further configured to determine a vehicle position estimate based at least in part on the lateral offset, the longitudinal offset, or both, and provide the vehicle position estimate to a system or device.

An example apparatus, according to the description, comprises means for obtaining location information for a vehicle, means for obtaining observation data regarding one or more visual features observed in a camera image taken from a vehicle, and means for determining a lateral offset and a longitudinal offset based on the location information and the observation data. The apparatus further comprises means for determining a vehicle position estimate based at least in part on the lateral offset, the longitudinal offset, or both, and means for providing the vehicle position estimate to a system or device.

An example non-transitory computer-readable medium, according to the description, has instructions stored thereby for estimating vehicle position. The instructions, when executed by one or more processing units, cause the one or more processing units to obtain location information for a vehicle, obtain observation data regarding one or more visual features observed in a camera image taken from the vehicle, and determine a lateral offset and a longitudinal offset based on the location information and the observation data. The instructions, when executed by one or more processing units, further cause the one or more processing units to determine a vehicle position estimate based at least in part on the lateral offset, the longitudinal offset, or both, and provide the vehicle position estimate to a system or device.

### BRIEF DESCRIPTION OF THE DRAWINGS

Aspects of the disclosure are illustrated by way of example.

FIG. 1 is a drawing of a perspective view of a vehicle;

FIG. 2 is a block diagram of a position estimation system, according to an embodiment;

FIG. 3 is an illustration of an overhead view of a vehicle on a road, illustrating what lateral and longitudinal offsets may comprise;

FIGS. 4A and 4B are charts showing performance results using techniques provided herein;

FIG. 5 is a flow diagram of a method of vehicle position estimation by tracking lateral and longitudinal offsets, according to an embodiment; and

FIG. 6 is a block diagram of an embodiment of a mobile computing system;

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

As used herein, the term “position estimate” is an estimation of the location of a vehicle within a frame of reference. This can mean, for example, an estimate of vehicle location on a 2-D coordinate frame (e.g., latitude and longitude on a 2-D map, etc.) or within a 3-D coordinate frame (e.g., latitude, longitude, and altitude (LLA) on a 3-D map), and may optionally include orientation information, such as heading. In some embodiments, a position estimate may include an estimate of six degrees of freedom (6DoF) (also known as “pose”), which includes translation (latitude, longitude, and altitude) and orientation (pitch, roll, and yaw) information.

It can be noted that, although embodiments described herein below are directed toward determining the position of a vehicle, embodiments are not so limited. Alternative embodiments, for example, may be directed toward other mobile devices and/or applications in which position determination is made. A person of ordinary skill in the art will recognize many variations to the embodiments described herein.

As previously noted, a vehicle position estimate having sub-meter accuracy (e.g., decimeter-level accuracy) within a map can be particularly helpful to an ADAS system for various planning and control algorithms for autonomous driving and other functionality. For example, it can enable the ADAS system to know where the vehicle is located within a driving lane on a road.

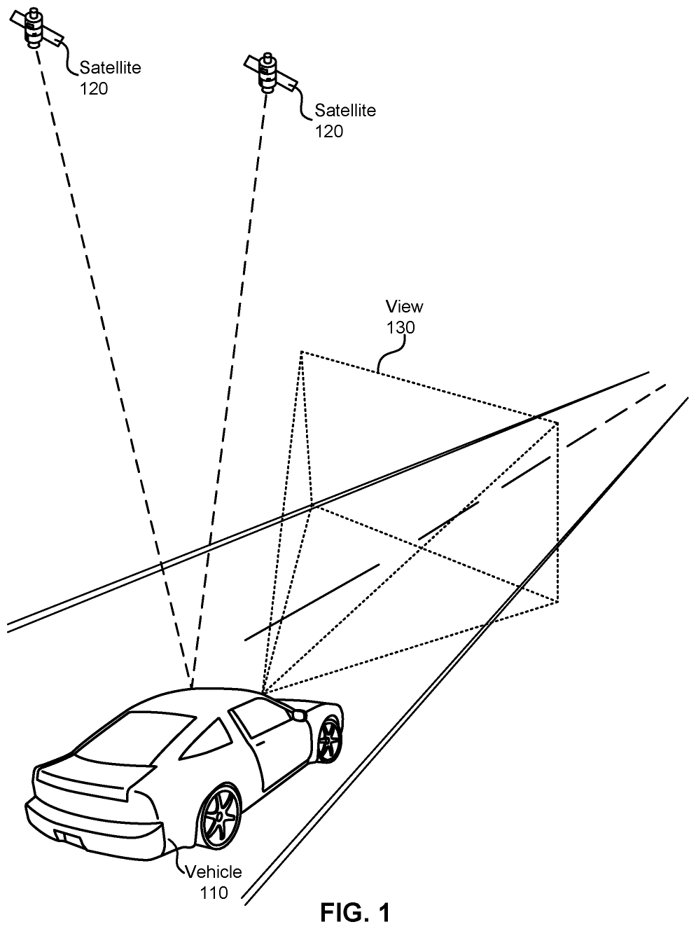

FIG. 1 is a drawing of a perspective view of a vehicle 110, illustrating how sub-meter accuracy may be provided to an ADAS system, according to embodiments. Satellites 120 may comprise satellite vehicles of a GNSS system that provide wireless (e.g., radio frequency (RF)) signals to a GNSS receiver on the vehicle 110 for determination of the position (e.g., using absolute or global coordinates) of the vehicle 110. (Of course, although satellites 120 in FIG. 1 are illustrated as relatively close to the vehicle 110 for visual simplicity, it will be understood that satellites 120 will be in orbit around the earth. Moreover the satellites 120 may be part of a large constellation of satellites of a GNSS system. Additional satellites of such a constellation are not shown in FIG. 1.)

Additionally, one or more cameras may capture images of the vehicle's surroundings. (E.g., a front-facing camera may take images (e.g., video) of a view 130 from the front of the vehicle 110.) Also, one or more motion sensors (e.g., accelerometers, gyroscopes, etc.) located on and/or in the vehicle 110 can provide motion data indicative of movement of the vehicle 110. VIO can be used to fuse the image and motion data to provide additional positioning information. This can then be used to increase the accuracy of the position estimate of the GNSS system, or as a substitute for a GNSS position estimate where a GNSS position estimate is not available (e.g., in tunnels, canyons, “urban canyons,” etc.).

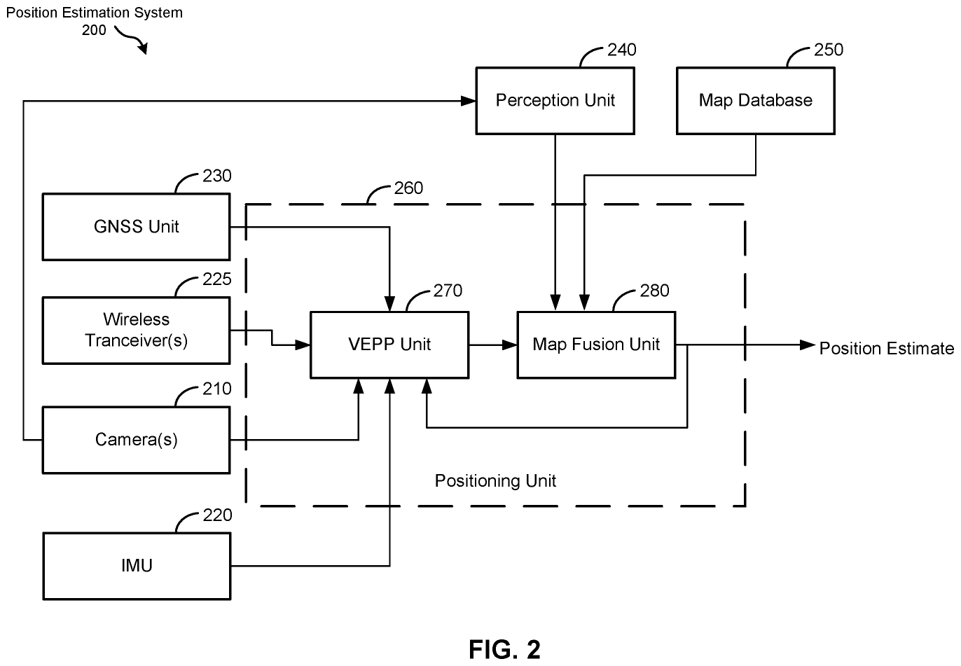

FIG. 2 is a block diagram of a position estimation system 200, according to an embodiment. The position estimation system 200 collects data from various different sources and outputs a position estimate of the vehicle, which can be used by an ADAS system and/or other systems on the vehicle, as well as systems (e.g., traffic monitoring systems) remote to the vehicle. The position estimation system 200 comprises one or more cameras 210, an inertial measurement unit (IMU) 220, a GNSS unit 230, a perception unit 240, a map database 250, and a positioning unit 260 comprising a vision-enhanced precise positioning (VEPP) unit 270 and a map fusion unit 280.

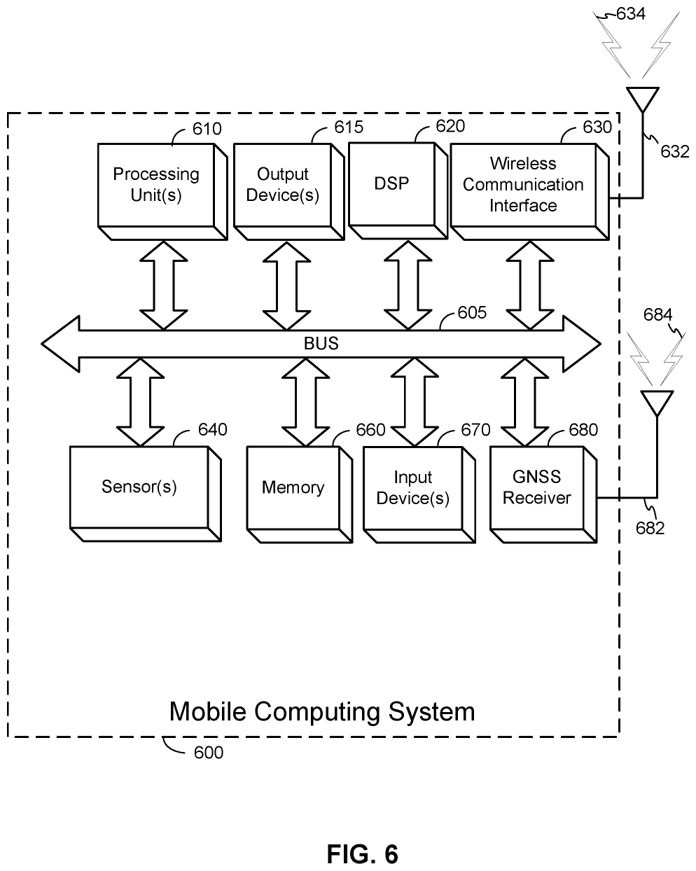

A person of ordinary skill in the art will understand that, in alternative embodiments, the components illustrated in FIG. 2 may be combined, separated, omitted, rearranged, and/or otherwise altered, depending on desired functionality. Moreover, in alternative embodiments, position estimation may be determined using additional or alternative data and/or data sources. One or more components of the position estimation system 200 may be implemented in hardware and/or software, such as one or more hardware and/or software components of the mobile computing system 600 illustrated in FIG. 6 and described in more detail below. These various hardware and/or software components may be distributed at various different locations on a vehicle, depending on desired functionality. For example, the positioning unit 260 may include one or more processing units.

Wireless transceiver(s) 225 may comprise one or more RF transceivers (e.g., Wi-Fi transceiver, Wireless Wide Area Network (WWAN) or cellular transceiver, Bluetooth transceiver, etc.) for receiving positioning data from various terrestrial positioning data sources. These terrestrial positioning data sources may include, for example, Wi-Fi Access Points (APs) (Wi-Fi signals including Dedicated Source Range Communications (DSRC) signals), cellular base stations (BSes) (e.g., cellular-based signals such as Positioning Reference Signals (PRS) or signals communicated via Vehicle-to-Everything (V2X), cellular V2X (CV2X), or Long-Term Evolution (LTE) direct protocols, etc.), and/or other positioning sources such as road side units (RSUs), etc. In some embodiments, in addition to data from the GNSS unit 230 and VIO (camera(s) 210 and IMU 220) the VEPP unit 270 may use such data from the wireless transceiver(s) 225 to determine a position determination by fusing data from these data sources.

The GNSS unit 230 may comprise a GNSS receiver and GNSS processing circuitry configured to receive signals from GNSS satellites (e.g., satellites 120) and GNSS-based positioning data. The positioning data output by the GNSS unit 230 can vary, depending on desired functionality. In some embodiments, the GNSS unit 230 will provide, among other things, a three-degrees-of-freedom (3DoF) position determination (e.g., latitude, longitude, and altitude). Additionally or alternatively, the GNSS unit 230 can output the underlying satellite measurements used to make the 3DoF position determination. Additionally, or alternatively, the GNSS unit can output raw measurements, such as pseudo-range and carrier-phase measurements.

The camera(s) 210 may comprise one or more cameras located on or in the vehicle, configured to capture images, from the perspective of the vehicle, to help track movement of the vehicle. The camera(s) 210 may be front-facing, upward-facing, backward-facing, downward-facing, and/or otherwise positioned on the vehicle. Other aspects of the camera(s) 210, such as resolution, optical band (e.g., visible light, infrared (IR), etc.), frame rate (e.g., 30 frames per second (FPS)), and the like, may be determined based on desired functionality. Movement of the vehicle 110 may be tracked from images captured by the camera(s) 210 using various image processing techniques to determine motion blur, object tracking, and the like. The raw images and/or information resulting therefrom may be passed to the VEPP unit 270, which may perform a VIO using the data from both the camera(s) 210 and the IMU 220.

IMU 220 may comprise one or more accelerometers, gyroscopes, and (optionally) other sensors, such as magnetometers, to provide inertial measurements. Similar to the camera(s) 210, the output of the IMU 220 to the VEPP unit 270 may vary, depending on desired functionality. In some embodiments, the output of the IMU 220 may comprise information indicative of a 3DoF position or 6DoF pose of the vehicle 110, and/or a 6DoF linear and angular velocities of the vehicle 110, and may be provided periodically, based on a schedule, and/or in response to a triggering event. The position information may be relative to an initial or reference position. Alternatively, the IMU 220 may provide raw sensor measurements.

The VEPP unit 270 may comprise a module (implemented in software and/or hardware) configured to perform of VIO by combining data received from the camera(s) 210 and IMU 220. For example, the data received may be given different weights based on input type, a confidence metric (or other indication of the reliability of the input), and the like. VIO may produce an estimate of 3DoF position and/or 6DoF pose based on received inputs. This estimated position may be relative to an initial or reference position. As noted above, the VEPP unit 270 may additionally or alternatively use information from the wireless transceiver(s) 225 to determine a position estimate.

The VEPP unit 270 can then combine the VIO position estimate with information from the GNSS unit 230 to provide vehicle position estimate in a global frame to the map fusion unit 280. The map fusion unit 280 works to provide a vehicle position estimate within a map frame, based on the position estimate from the VEPP unit 270, as well as information from a map database 250 and a perception unit 240. The map database 250 can provide a 3-D map (e.g., a high definition (HD) map) of an area in which the vehicle 110 is located, and the perception unit 240 can make observations of lane markings, traffic signs, and/or other visual features in the vehicle's surroundings. To do so, the perception unit 240 may comprise a feature-extraction engine that performs image processing and computer vision on images received from the camera(s) 210.

According to embodiments, the map data received from the map database 250 may be limited to conserve processing and storage requirements. For example, map data provided from the map database 250 to the map fusion unit 280 may be limited to locations within a certain distance around the estimated position of the vehicle 110, locations within a certain distance in front of the estimated position of the vehicle 110, locations estimated to be within a field of view of a camera, or any combination thereof

The position estimate provided by the map fusion unit 280 (i.e., the output of the positioning unit 260) may serve any of a variety of functions, depending on desired functionality. For example, it may be provided to ADAS or other systems of the vehicle 110 (and may be conveyed via a controller area network (CAN) bus), communicated to devices separate from the vehicle 110 (including other vehicles; servers maintained by government agencies, service providers, and the like; etc.), shown on a display of the vehicle (e.g., to a driver or other user for navigation or other purposes), and the like.

According to embodiments, to provide an accurate position estimate within the map frame of the map retrieved from the map database 250, the map fusion unit 280 can track offsets between the position estimate in the global frame and the vehicle position in the map frame, where offsets are tracked in both lateral and longitudinal directions. These lateral and longitudinal offsets can include not only errors in the position estimates in both lateral and longitudinal directions, but also inconsistencies between the map frame and the global frame.

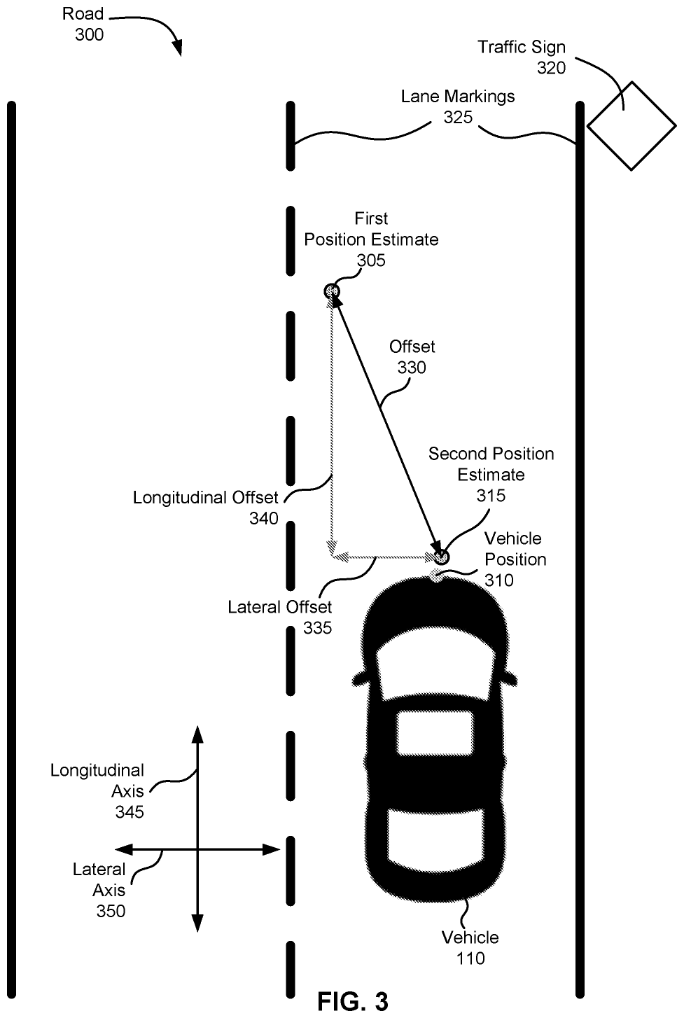

FIG. 3 is an illustration of an overhead view of a vehicle 110 on a road 300, provided here to illustrate what lateral and longitudinal offsets may comprise. The first position estimate 305 provides an initial estimate a vehicle position 310 located at the front of the vehicle 110. (It can be noted that, alternative embodiments may use a different convention for where the vehicle position 310, is located on the vehicle 110.) As previously noted, the first position estimate 305 may be a VEPP position estimate based on GNSS and/or VIO position estimates.

To provide a more accurate second position estimate 315 (which, as illustrated, may still include some error) the map fusion unit 380 can execute an extended Kalman filter (EKF) (or other such positioning filter) that provides a second position estimate based on the first position estimate 305 as well as camera observations of visual features on or near the road 300, such as traffic sign 320 and/or lane markings 325, the locations of which are found in the map data used by the map fusion unit 380. The difference in location between the first position estimate 305 and the second position estimate 315 comprises an offset 330 that, as previously indicated, may reflect errors in the first position estimate 305 as well as inconsistencies between the global frame used for the VEPP position estimate and the map frame. This offset 330 can be broken down into lateral and longitudinal components: lateral offset 335, and longitudinal offset 340.

As previously noted, “longitudinal” and “lateral” directions may be based on the direction of the lane in which the vehicle 110 is located (which can be determined from map data for the lane markings 325, as described below). Alternatively, if the map data happens to be unavailable at the vehicle's current location, then longitudinal and lateral directions may be based on a coordinate system that has a longitudinal axis 345 in the direction of the vehicle's heading, and a lateral axis 350 perpendicular to the longitudinal axis 345, where both axes are in the plane of the road 300 on which the vehicle 110 is located. (Under most circumstances, the direction of the road 300 is substantially the same direction of the vehicle's heading.) Other embodiments may determine longitudinal and lateral directions in other ways.

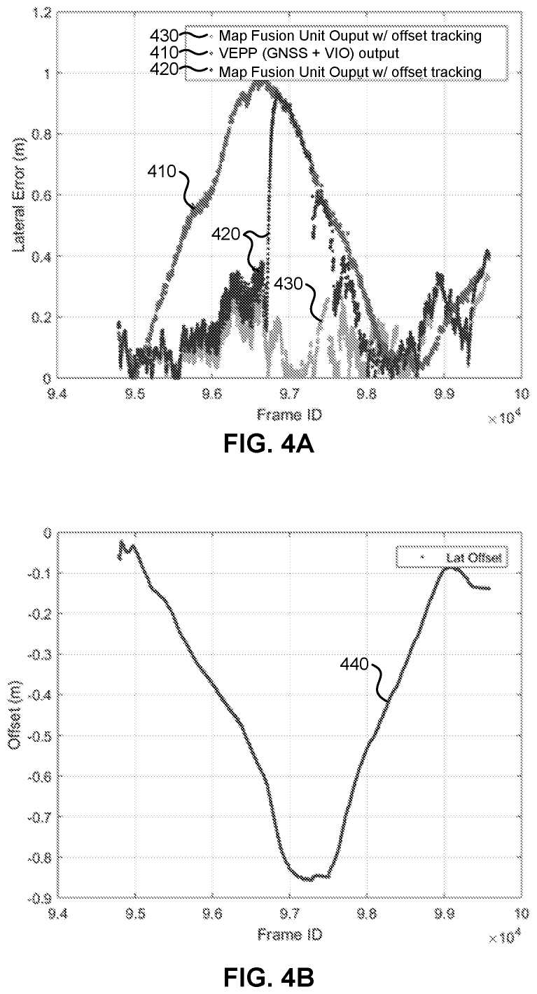

By tracking lateral offset 335 and longitudinal offset 340 separate from the second position estimate 315, more accurate error correction may be made. This is because lateral offset 335 and longitudinal offset 340 can be indicative of inconsistencies between the mapping global coordinates, and separate tracking of these offsets can enable EKF to more accurately compensate for them. (See FIGS. 4A and 4B, which are described in more detail below.)

The lateral offset 335 and longitudinal offset 340 are directly observable from the difference between the first position estimate 305 and the second position estimate 315. According to some embodiments, a measurement model for the EKF that characterizes the relationship between the first position estimate 305 and the second position estimate 315 as a function of the lateral and longitudinal offsets can be given by:

$$[ \begin{matrix}{x}_{t}^{V E P P} \\ {y}_{t}^{V E P P}\end{matrix} ] = [ \begin{matrix}{x}_{t}^{M F} \\ {y}_{t}^{M F}\end{matrix} ] + [ \begin{matrix}{Δ}_{t}^{x} \\ {Δ}_{t}^{y}\end{matrix} ] + {m}_{t}^{Δ} \qquad ( 1 )$$

where xₜ^{VEPP} and yₜ^{VEPP} are the east and north coordinates of the first position estimate 305 in the map frame at time t, which are converted to the East, North, Up (ENU) coordinate system from the global frame and can be viewed as a measurement in the EKF of the map fusion unit 280. Additionally, the terms xₜ^{MF} and yₜ^{MF} are the coordinates (in the map ENU frame) of the second position estimate 315 made by the map fusion unit 280, Δₜ^{x} and Δₜ^{y} are the positional offsets along the east and north directions of the map frame, and mₜ^{Δ} is the measurement noise.

Given the longitudinal direction [cos β sin β]^{T}, i.e., the direction of the vehicle's movement (along the longitudinal axis 345), the positional offsets along the x and y directions of the global frame can be expressed in terms of the lateral offset 335 and longitudinal offset 340 multiplied by rotation matrix, as follows:

$$[ \begin{matrix}{Δ}_{t}^{x} \\ {Δ}_{t}^{y}\end{matrix} ] = [ \begin{matrix}cos β & - s in β \\ sin β & cos β\end{matrix} ] [ \begin{matrix}{Δ}_{t}^{lat} \\ {Δ}_{t}^{l o n}\end{matrix} ] , \qquad ( 2 )$$

where Δₜ^{lat} and Δₜ^{lon} are the lateral offset 335 and longitudinal offset 340, respectively.

Combining (1) and (2), the measurement model that involves Δₜ^{lat} and Δₜ^{lon} is given by:

$$[ \begin{matrix}{x}_{t}^{V E P P} \\ {y}_{t}^{V E P P}\end{matrix} ] = [ \begin{matrix}{x}_{t}^{M F} \\ {y}_{t}^{M F}\end{matrix} ] + [ \begin{matrix}cos β & - s in β \\ sin β & β cos\end{matrix} ] [ \begin{matrix}{Δ}_{t}^{lat} \\ {Δ}_{t}^{l o n}\end{matrix} ] + {m}_{t}^{Δ} . \qquad ( 3 )$$

To effectively track the lateral and longitudinal offsets Δₜ^{lat} and Δₜ^{lon} in the EKF of the map fusion unit 280, the longitudinal direction [cos β sin β]^{T} can be estimated first. According to some embodiments, an estimate of the vehicle's heading vector uₜ (as provided in the first position estimate 305 or the second position estimate 315) may be used as the longitudinal direction. This technique can, however, result in estimation errors for the longitudinal direction since the vehicle heading is not necessarily always parallel to the lane in which the vehicle is located, and the heading itself involves estimation errors.

To avoid estimation errors, a refined longitudinal direction [cos β sin β]^{T} may be extracted from the map, as previously mentioned. For example, based on the second position estimate 315, map data for a lane boundary (corresponding to lane markings 325) closest to the vehicle can be extracted, and the longitudinal direction can be determined as the direction of this lane boundary, considering that the direction of the vehicle should follow the lane direction.

According to some embodiments, a lane boundary is represented in the map data by a series of points, each point having coordinates (2-D or 3-D) in the map frame. Thus, embodiments may select the two points, pₜ^{a} and pₜ^{b}, on the lane boundary closest to the second position estimate 315 and determine the longitudinal direction (along the longitudinal axis 345) as follows.

Let the 3D vector uₜ be the vehicle heading (from the first position estimate 305 or the second position estimate 315). Let pₜ^{a}[1:2], pₜ^{b}[1:2], and uₜ[1:2] be the vectors consisting of the first two elements of the 3D vectors pₜ^{a}, pₜ^{b}, and uₜ, respectively. If (pₜ^{a}[1:2]−pₜ^{b}[1:2])^{T} uₜ[1:2]>0, then the direction from pₜ^{a} to pₜ^{b} is the direction of movement, and in this case:

$$[ \begin{matrix}cos β \\ sin β\end{matrix} ] = \frac{{p}_{t}^{a} [ 1 \text{:} 2 ] - {p}_{t}^{b} [ 1 \text{:} 2 ]}{‖ {p}_{t}^{a} [ 1 \text{:} 2 ] - {p}_{t}^{b} [ 1 \text{:} 2 ] ‖} . \qquad ( 4 )$$

If (pₜ^{a}[1:2]−pₜ^{b}[1:2])^{T}uₜ[1:2]<0, then the direction from pₜ^{b} to pₜ^{a} is the direction of movement, and in this case:

$$[ \begin{matrix}cos β \\ sin β\end{matrix} ] = \frac{{p}_{t}^{b} [ 1 \text{:} 2 ] - {p}_{t}^{a} [ 1 \text{:} 2 ]}{‖ {p}_{t}^{a} [ 1 \text{:} 2 ] - {p}_{t}^{b} [ 1 \text{:} 2 ] ‖} . \qquad ( 5 )$$

In this manner, the longitudinal direction can be calculated in a way that may be more reliable and stable compared with the estimation of vehicle's heading.

To enable the EKF to provide subsequent position estimates using the longitudinal and lateral offsets, a motion model for the lateral and longitudinal offsets may be designed as follows:

$$[ \begin{matrix}{Δ}_{t + 1}^{lat} \\ {Δ}_{t + 1}^{l o n}\end{matrix} ] = [ \begin{matrix}{Δ}_{t}^{lat} \\ {Δ}_{t}^{l o n}\end{matrix} ] + [ \begin{matrix}{w}_{t + 1}^{lat} \\ {w}_{t + 1}^{l o n}\end{matrix} ] , \qquad ( 6 )$$

where wₜ₊₁^{lat} and wₜ₊₁^{lon} are motion noises following zero-mean Gaussian distributions with standard deviation being latOffsetPct×dₜ₊₁ and lonOffsetPct×dₜ₊₁, in which dₜ₊₁ is the estimated displacement of the vehicle from time t to t+1, and the parameters latOffsetPct and lonOffsetPct characterize the amount of lateral and longitudinal offsets that are expected per meter of displacement.

Given the measurement model (3) and motion model (6), an EKF can be easily applied for tracking the lateral and longitudinal offsets jointly with the 6DoF pose. The two offsets will track the VEPP positioning errors and inconsistencies between the global and map frames, as well as hold the useful corrections on the position estimate from camera observations.

Furthermore, such embodiments allow for the estimation of lateral and longitudinal offsets to different levels of accuracy. For example, if only the lane markings 325 on the road 300 are observed, then camera observation and map mainly provide positional information along the lateral direction, due to the fact that lane markings 325 can generally provide good lateral resolution, but may not provide much longitudinal resolution. When the lateral direction changes at map curves, the information in the previous lateral direction can be propagated to the longitudinal direction. In addition, the accurate knowledge about the longitudinal vector based on the map allows the decomposition of positioning errors along the lateral and longitudinal directions, which enables more intuitive analysis of the positioning accuracy of the vehicle along the lateral and longitudinal directions.

According to some embodiments, the longitudinal offset 340 and lateral offset 335 can be an explicit output by the map fusion unit 280, and may be used by systems and entities other than those on the vehicle. For example, these offsets may be provided to a map service provider (e.g., the provider of the map kept in the map database 250), who may use the information to identify and correct inconsistencies between the global frame and the map frame.

FIGS. 4A and 4B are charts showing performance results using the techniques provided herein. The charts illustrate how lateral and longitudinal offset tracking as described herein can result in a position estimate with higher accuracy, in an example scenario. Since only lane marking is used for this scenario, the performance improvement is mainly along the lateral direction.

FIG. 4A is a chart in which the lateral error (in meters) is plotted over a period of time for various outputs. A first plot 410 shows an output of the VEPP unit 270 (based on GNSS and VIO), a second plot 420 chosen output of the map fusion unit 280 without tracking the lateral and longitudinal offsets, and finally a third plot 430 chosen output of the map fusion unit 280 for which lateral and longitudinal offsets are tracked. FIG. 4B is a chart with a plot 440 of the lateral offset (in meters) over the same period of time as a chart in FIG. 4A. Results for longitudinal offsets may be similar.

As can be seen, the lateral error of both the VEPP unit 270 (shown by first plot 410) and the map fusion unit 280 without offset tracking (shown by second plot 420) peak at or near the peak of the magnitude (absolute value) of the lateral offset (plot 440). However, the output of the map fusion unit 280 that also tracks lateral and longitudinal offsets (shown by third plot 430) is virtually unaffected by the lateral offset caused by the large VEPP lateral error, and the lateral error remains low (below approximately 0.3 m for virtually the entire period of time).

Although embodiments described above discuss the use of lateral and longitudinal offsets in determining a more accurate vehicle position estimate, some embodiments may further use vertical offsets. That is, although tracking lateral and longitudinal offsets (a horizontal offset) can be a reasonably good approximation in many instances, such as instances in which the ground plane underneath the vehicle is substantially parallel to the east-north plane of the ENU coordinate system, and GNSS and HD map information regarding vertical location is relatively accurate. However, because GNSS signal and HD map information often have worse vertical accuracy than horizontal accuracy, and because the ground plane on which the vehicle is situated may have a nontrivial angle from the east-north plane (e.g., lies on an uphill or downhill slope), it may be beneficial to track and correct for vertical offset in addition to horizontal offset. In such instances, the measurement model (1) above can be expanded as follows:

$$[ \begin{matrix}\begin{matrix}{x}_{t}^{V E P P} \\ {y}_{t}^{V E P P}\end{matrix} \\ {z}_{t}^{V E P P}\end{matrix} ] = [ \begin{matrix}{x}_{t}^{M F} \\ {y}_{t}^{M F} \\ {z}_{t}^{MF}\end{matrix} ] + [ \begin{matrix}{Δ}_{t}^{x} \\ {Δ}_{t}^{x} \\ {Δ}_{t}^{z}\end{matrix} ] + {m}_{t}^{Δ} \qquad ( 7 )$$

where xₜ^{VEPP}, yₜ^{VEPP}, and zₜ^{VEPP} are the respective east, north, and up coordinates of a first position estimate in the map frame at time t, which are converted to the East, North, Up (ENU) coordinate system from the global frame and can be viewed as a measurement in the EKF of the map fusion unit 280. Additionally, the terms xₜ^{MF}, yₜ^{MF}, and zₜ^{MF} are the coordinates (in the map ENU frame) of a second position estimate made by the map fusion unit 280, ←ₜ^{x}, Δₜ^{y}, and Δₜ^{z} are the positional offsets along the east, north, and vertical directions of the map frame, and mₜ^{Δ} is the measurement noise.

Given the longitudinal direction [cos β sin β]^{T}, i.e., the direction of the vehicle's movement (along the longitudinal axis 345), the positional offsets along the x and y directions of the global frame can be expressed in terms of the lateral offset 335 and longitudinal offset 340 multiplied by rotation matrix, as follows:

$$[ \begin{matrix}{Δ}_{t}^{x} \\ {Δ}_{t}^{y} \\ {Δ}_{t}^{z}\end{matrix} ] = R [ \begin{matrix}{Δ}_{t}^{lat} \\ {Δ}_{t}^{l o n} \\ {Δ}_{t}^{ver}\end{matrix} ] , \qquad ( 8 )$$

where Δₜ^{lat}, Δₜ^{lon}, and Δₜ^{ver} are the lateral offset 335, longitudinal offset 340, and vertical offset (not shown), respectively. Additionally, R is a 3-by-3 rotation matrix defined by its columns:

R=[uₗₐₜ, uₗₒₙ, uᵥₑᵣ], (9)

where uₗₐₜ, uₗₒₙ, and uᵥₑᵣ are 3-by-1 unit vectors in lateral, longitudinal, and vertical directions in the ENU frame, respectively.

Additionally, with respect to equations (4) and (5) above, they can be expanded to include the vertical direction as follows.

The lane direction uₗₒₙ can be found by the two nearest HD map points pₜ^{a} and pₜ^{b} in the 3D ENU frame.
If (pₜ^{a}−pₜ^{b})^{T}uₜ>0, where uₜ is the vehicle heading direction in the 3D ENU frame, then

$${u}_{l o n} = \frac{{p}_{t}^{a} - {p}_{t}^{b}}{‖ {p}_{t}^{a} - {p}_{t}^{b} ‖} . \qquad ( 10 )$$

Otherwise:

$${u}_{l o n} = \frac{{p}_{t}^{b} - {p}_{t}^{a}}{‖ {p}_{t}^{a} - {p}_{t}^{b} ‖} . \qquad ( 11 )$$

Here, the direction vectors uₗₒₙ and uₗₐₜ, belong to the vehicle ground plane based on the HD map. Accordingly, uₗₐₜ may be found perpendicular to uₗₒₙ in the ground plane. Furthermore, the vertical direction uᵥₑᵣ can be determined as a unit vector normal to the ground plane.

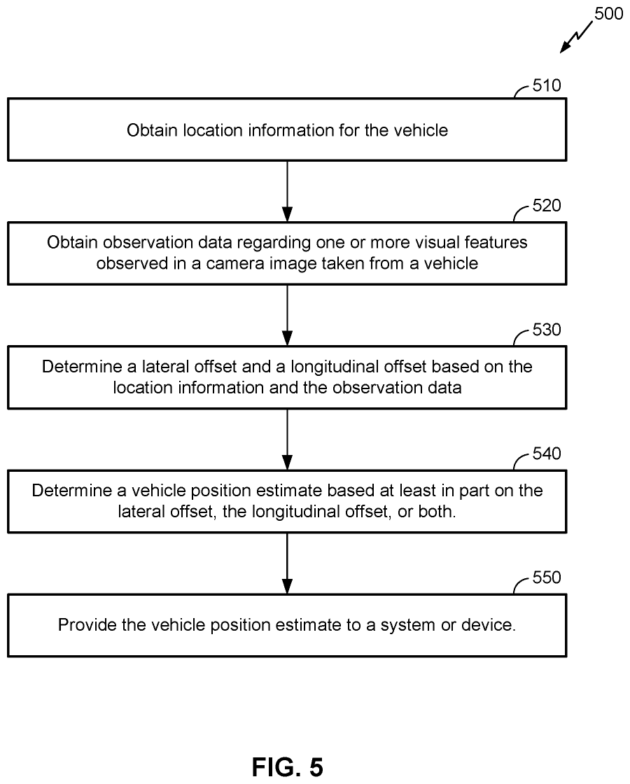

FIG. 5 is a flow diagram of a method 500 of vehicle position estimation by tracking lateral and longitudinal offsets, according to an embodiment. Alternative embodiments may perform functions in alternative order, combine, separate, and/or rearrange the functions illustrated in the blocks of FIG. 5, and/or perform functions in parallel, depending on desired functionality. A person of ordinary skill in the art will appreciate such variations. Means for performing the functionality of one or more blocks illustrated in FIG. 5 can include a map fusion unit 280 or, more broadly, a positioning unit 260, for example. Either of these units may be implemented by a processing unit and/or other hardware and/or software components of an on-vehicle computer system, such as the mobile computing system 600 of FIG. 6, described in further detail below. Additionally or alternatively, such means may include specialized hardware and/or software corresponding to the components illustrated in FIG. 2.

At block 510, location information for the vehicle is obtained. As noted, this location information may comprise GNSS information, VIO information, wireless terrestrial location information (e.g., information enabling the determination of the location of the vehicle from terrestrial wireless sources), or any combination thereof In some embodiments, this information may include a first vehicle position estimate. Additionally or alternatively, this information may comprise underlying GNSS and/or VIO information that can be used to obtain a position estimate. According to some embodiments, a first vehicle position estimate may be determined in a global frame, based on the location information. Means for performing the functionality of block 510 may include a bus 605, processing unit(s) 610, wireless communication interface 630, GNSS receiver 680, sensor(s) 640, memory 660, and/or other components of a mobile computing system 600 as illustrated in FIG. 6 and described in further detail below.

At block 520, observation data is obtained regarding one or more visual features observed in a camera image taken from the vehicle. As indicated in the description above, feature detection may be performed on an image (e.g., obtained from a front-facing camera on the vehicle) to identify features (such as lane markings 325, traffic signs 320, and the like) that may be matched with corresponding features within map data. Means for performing the functionality of block 520 may include a bus 605, processing unit(s) 610, input device(s) 615, working memory 635, and/or other components of a mobile computing system 600 as illustrated in FIG. 6 and described in further detail below.

At block 530, a lateral offset and a longitudinal offset is determined, based on the location information and the observation data. As indicated previously, this may involve the use of a rotation matrix and the determination of a longitudinal direction. According to some embodiments, the method 500 may therefore comprise determining a longitudinal direction for the longitudinal offset based on a direction derived from a lane boundary obtained from map data. (The latitude direction can then be derived from the longitudinal direction.) According to some embodiments, the method 500 may further deriving the direction from the lane boundary at least in part by identifying the two points on the lane boundary, and deriving the direction from the to identify points. As previously noted, in some embodiments, the two points may represent the two closest points in the closest lane boundary to a second vehicle position estimate, which may be based on map data, where the map data is in a map frame. By determining a location of an identified feature relative to the vehicle (e.g., as determined from the feature's location within the image) and further obtaining the location for the identified features within the map frame obtained from a map, the second vehicle position can be accurately located within the map. In embodiments in which the initial vehicle position estimate is provided in a global frame, the lateral offset and longitudinal offset may then be indicative of a difference between the global frame and the map frame. Means for performing the functionality of block 530 may include a bus 605, processing unit(s) 610, input device(s) 615, working memory 635, and/or other components of a mobile computing system 600 as illustrated in FIG. 6 and described in further detail below.

At block 540, a vehicle position estimate is determined based at least in part on the lateral offset, the longitudinal offset, or both. As described in the embodiments provided herein, an EKF may be used to determine vehicle position estimate, and may be used to track the lateral offset and/or longitudinal offset. In some embodiments, determining a subsequent vehicle position based at least in part on the lateral offset, the longitudinal offset, or both may comprise using the lateral offset, the longitudinal offset, or both in a motion model of an EKF. Means for performing the functionality of block 540 may include a bus 605, processing unit(s) 610, input device(s) 615, working memory 635, and/or other components of a mobile computing system 600 as illustrated in FIG. 6 and described in further detail below.

At block 550 the method comprises providing the vehicle position estimate to a system or device. As indicated above, such systems or devices may be located on the vehicle. These systems or devices may include, for example ADAS or other systems of the vehicle capable of providing autonomous or semi-autonomous functionality, a navigation system, display device, or the like. Depending on desired functionality, the vehicle position estimate may be conveyed via a CAN or other data bus. In some embodiments, the vehicle position estimate may be provided (e.g., wirelessly) to one or more remote systems or devices, such as a traffic management server, one or more remote vehicles, or the like. Some embodiments may additionally or alternatively include providing the lateral offset, the longitudinal offset, or both. Means for performing the functionality of block 550 may include a bus 605, processing unit(s) 610, input device(s) 615, working memory 635, communications subsystem 630, and/or other components of a mobile computing system 600 as illustrated in FIG. 6 and described in further detail below.

FIG. 6 illustrates an embodiment of a mobile computing system 600, which may be used to perform some or all of the functionality described in the embodiments herein, including the functionality of one or more of the blocks illustrated in FIG. 5. The mobile computing system 600 may be located on a vehicle, and may include some or all of the components of the position estimation system 200 of FIG. 2. For example, as previously noted, the positioning unit 260 of FIG. 2 may be executed by processing unit(s) 610; the IMU 220 and camera(s) 210 may be incorporated into sensor(s) 640; and/or GNSS unit 230 may be included in the GNSS receiver 680; and so forth. A person of ordinary skill in the art will appreciate where additional or alternative. It can be noted that, in some instances, components illustrated by FIG. 6 can be localized to a single physical device and/or distributed among various networked devices, which may be located at different physical locations (e.g., located at different locations of a vehicle).

The mobile computing system 600 is shown comprising hardware elements that can be electrically coupled via a bus 605 (or may otherwise be in communication, as appropriate). The hardware elements may include a processing unit(s) 610 which can include without limitation one or more general-purpose processors, one or more special-purpose processors (such as digital signal processing (DSP) chips, graphics acceleration processors, application specific integrated circuits (ASICs), and/or the like), and/or other processing structure or means. As shown in FIG. 6, some embodiments may have a separate Digital Signal Processor (DSP) 620, depending on desired functionality. Location determination and/or other determinations based on wireless communication may be provided in the processing unit(s) 610 and/or wireless communication interface 630 (discussed below). The mobile computing system 600 also can include one or more input devices 670, which can include without limitation a keyboard, touch screen, a touch pad, microphone, button(s), dial(s), switch(es), and/or the like; and one or more output devices 615, which can include without limitation a display, light emitting diode (LED), speakers, electrical vehicle systems, and/or the like.

The mobile computing system 600 may also include a wireless communication interface 630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX™ device, a Wide Area Network (WAN) device and/or various cellular devices, etc.), and/or the like, which may enable the mobile computing system 600 to communicate data via the one or more data communication networks. The communication can be carried out via one or more wireless communication antenna(s) 632 that send and/or receive wireless signals 634.

Depending on desired functionality, the wireless communication interface 630 may comprise separate transceivers to communicate terrestrial transceivers, such as wireless devices, base stations, and/or access points. The mobile computing system 600 may communicate with different data networks that may comprise various network types. For example, a WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16) network, and so on. A CDMA network may implement one or more radio access technologies (RATs) such as CDMA2000, Wideband CDMA (WCDMA), and so on. Cdma2000 includes IS-95, IS-2000, and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from the Third Generation Partnership Project (3GPP). Cdma2000 is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or Wireless Personal Area Network (WPAN).

The mobile computing system 600 can further include sensor(s) 640. Sensors 640 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to complement and/or facilitate the position determination described herein, in some instances. In some embodiments, one or more cameras included in the sensor(s) 640 may be used to obtain the images as described in the embodiments presented herein used by the VEPP unit 270, perception unit 240, and the like. Additionally or alternatively, inertial sensors included in the sensor(s) 640 may be used to determine the orientation of the camera and/or mobile device, as described in the embodiments above.

Embodiments of the mobile computing system 600 may also include a GNSS receiver 680 capable of receiving signals 684 from one or more GNSS satellites (e.g., SVs 140) using an antenna 682 (which could be the same as antenna 632). Positioning based on GNSS signal measurement can be utilized to complement and/or incorporate the techniques described herein. The GNSS receiver 680 can extract a position of the mobile computing system 600, using conventional techniques, from GNSS SVs of a GNSS system (e.g., SVs 140 of FIG. 1), such as Global Positioning System (GPS), Galileo, Glonass, Quasi-Zenith Satellite System (QZSS) over Japan, Indian Regional Navigational Satellite System (IRNSS) over India, Beidou over China, and/or the like. Moreover, the GNSS receiver 680 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi -functional Satellite Augmentation System (MSAS), and Geo Augmented Navigation system (GAGAN), and/or the like.

The mobile computing system 600 may further include and/or be in communication with a memory 660. The memory 660 can include, without limitation, local and/or network accessible storage, a disk drive, a drive array, an optical storage device, a solid-state storage device, such as a Random Access Memory (RAM), and/or a Read-Only Memory (ROM), which can be programmable, flash-updateable, and/or the like. Such storage devices may be configured to implement any appropriate data stores, including without limitation, various file systems, database structures, and/or the like.

The memory 660 of the mobile computing system 600 also can comprise software elements (not shown in FIG. 6), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 660 that are executable by the mobile computing system 600 (and/or processing unit(s) 610 or DSP 620 within mobile computing system 600). In an aspect, then, such code and/or instructions can be used to configure and/or adapt a general purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

What is claimed is:

1. A method of vehicle position estimation, the method comprising:
obtaining location information for a vehicle;
obtaining observation data regarding one or more visual features observed in a camera image taken from the vehicle;
determining a lateral offset and a longitudinal offset based on the location information and the observation data;
determining a vehicle position estimate based at least in part on the lateral offset, the longitudinal offset, or both; and
providing the vehicle position estimate to a system or device.

2. The method of claim 1, wherein the system or device is located on the vehicle.

3. The method of claim 1, further comprising determining a longitudinal direction for the longitudinal offset based on a direction derived from a lane boundary obtained from map data.

4. The method of claim 3, further comprising deriving the direction from the lane boundary at least in part by:
identifying two points on the lane boundary; and
deriving the direction from the two identified points.

5. The method of claim 1, further comprising determining a first vehicle position estimate in a global frame, based on the location information.

6. The method of claim 5, further comprising determining a second vehicle position estimate based on map data, wherein:
the map data is in a map frame; and
the lateral offset and the longitudinal offset are indicative of a difference between the global frame and the map frame.

7. The method of claim 1, wherein determining the vehicle position estimate comprises using the lateral offset, the longitudinal offset, or both in a motion model of an extended Kalman filter (EKF).

8. The method of claim 1, further comprising providing the lateral offset, the longitudinal offset, or both to a system or device of the vehicle.

9. The method of claim 1, further comprising determining a vertical offset based on the location information and the observation data, wherein determining the vehicle position estimate is further based on the vertical offset.

10. The method of claim 1, wherein the location information comprises:
Global Navigation Satellite System (GNSS) information;
wireless terrestrial location information; or
Visual Inertial Odometry (VIO) information; or
any combination thereof

11. A mobile device comprising:
a camera,
a memory; and
one or more processing units communicatively connected with the memory and the camera, and configured to:
obtain location information for a vehicle;
obtain observation data regarding one or more visual features observed in a camera image taken from the vehicle by the camera;
determine a lateral offset and a longitudinal offset based on the location information and the observation data;
determine a vehicle position estimate based at least in part on the lateral offset, the longitudinal offset, or both; and
provide the vehicle position estimate to a system or device.

12. The mobile device of claim 11, wherein the one or more processing units are further configured to determine a longitudinal direction for the longitudinal offset based on a direction derived from a lane boundary obtained from map data.

13. The mobile device of claim 12, wherein, to derive the direction from the lane boundary, the one or more processing units are configured to:
identify two points on the lane boundary; and
derive the direction from the two identified points.

14. The mobile device of claim 11, wherein the one or more processing units are further configured to determine a first vehicle position estimate in a global frame, based on the location information.

15. The mobile device of claim 14, wherein the one or more processing units are further configured to determine a second vehicle position estimate based on map data, wherein:
the map data is in a map frame; and
the lateral offset and the longitudinal offset are indicative of a difference between the global frame and the map frame.

16. The mobile device of claim 11, wherein, to determine the vehicle position estimate, the one or more processing units are configured to use the lateral offset, the longitudinal offset, or both in a motion model of an extended Kalman filter (EKF).

17. The mobile device of claim 11, wherein the one or more processing units are further configured to provide the lateral offset, the longitudinal offset, or both to a system or device of the vehicle.

18. The mobile device of claim 11, wherein the one or more processing units are further configured to:
determine a vertical offset based on the location information and the observation data, and
further base the determination of the vehicle position estimate on the vertical offset.

19. The mobile device of claim 11, wherein, to obtain the location information, the one or more processing units are further configured to obtain:
Global Navigation Satellite System (GNSS) information;
wireless terrestrial location information; or
Visual Inertial Odometry (VIO) information; or
any combination thereof.

20. An apparatus comprising:
means for obtaining location information for a vehicle;
means for obtaining observation data regarding one or more visual features observed in a camera image taken from a vehicle;
means for determining a lateral offset and a longitudinal offset based on the location information and the observation data;
means for determining a vehicle position estimate based at least in part on the lateral offset, the longitudinal offset, or both; and
means for providing the vehicle position estimate to a system or device.

21. The apparatus of claim 20, further comprising means for determining a longitudinal direction for the longitudinal offset based on a direction derived from a lane boundary obtained from map data.

22. The apparatus of claim 21, further comprising means for deriving the direction from the lane boundary at least in part by:
identifying two points on the lane boundary; and
deriving the direction from the two identified points.

23. The apparatus of claim 20, further comprising means for determining a first vehicle position estimate in a global frame, based on the location information.

24. The apparatus of claim 23, further comprising means for determining a second vehicle position estimate based on map data, wherein:
the map data is in a map frame; and
the lateral offset and the longitudinal offset are indicative of a difference between the global frame and the map frame.

25. The apparatus of claim 20, wherein the means for determining the vehicle position estimate comprise means for using the lateral offset, the longitudinal offset, or both in a motion model of an extended Kalman filter (EKF).

26. The apparatus of claim 20, further comprising means for providing the lateral offset, the longitudinal offset, or both to a system or device of the vehicle.

27. The apparatus of claim 20, further comprising means for determining a vertical offset based on the location information and the observation data, wherein determining the vehicle position estimate is further based on the vertical offset.

28. A non-transitory computer-readable medium having instructions stored thereby for estimating vehicle position, wherein the instructions, when executed by one or more processing units, cause the one or more processing units to:
obtain location information for a vehicle;
obtain observation data regarding one or more visual features observed in a camera image taken from the vehicle;
determine a lateral offset and a longitudinal offset based on the location information and the observation data;
determine a vehicle position estimate based at least in part on the lateral offset, the longitudinal offset, or both; and
provide the vehicle position estimate to a system or device.

29. The non-transitory computer-readable medium of claim 28, wherein, the instructions, when executed by the one or more processing units, further cause the one or more processing units to determine a longitudinal direction for the longitudinal offset based on a direction derived from a lane boundary obtained from map data.

30. The non-transitory computer-readable medium of claim 29 wherein, the instructions, when executed by the one or more processing units, further cause the one or more processing units to derive the direction from the lane boundary at least in part by:
identifying two points on the lane boundary; and
deriving the direction from the two identified points.
